(19) United States
(12) Patent Application Publication
(10) Pub. No.: US 2023/0162144 A1
(43) Pub. Date: May 25, 2023

(54) INVENTORY SYSTEM AND METHOD FOR MEASURING THE CONTENTS OF FULL AND PARTIALLY-FILLED ALCOHOL BEVERAGE CONTAINERS

(71) Applicant: SBS TECHNOLOGIES LLC, Dover, DE (US)

(72) Inventor: Martin D. WILLARD, Philadelphia, PA (US)

(21) Appl. No.: 17/915,145

(22) PCT Filed: Mar. 25, 2021
(86) PCT No.: PCT/US2021/024175

§ 371 Date: Sep. 28, 2022

Related U.S. Application Data
(60) Provisional application No. 63/001,622, filed on Mar. 30, 2020.

(51) Int. Cl. G06Q 10/087; G06K 7/10

(52) U.S. Cl. CPC G06Q 10/087; G06K 7/10881

(57) ABSTRACT

A system and method for accurately measuring the volume of full or partially-filled containers via UPC-A standard barcode and weight. After initial connection to the wireless Internet, no input is required by the user. Bottles are placed on a load cell with the barcode label rotated to face an omni-directional barcode reader. The load cell ensures objective and reproducible inventory counts, and the barcode ensures accuracy and speed. The apparatus automatically shuts off after a period of idleness to preserve battery life.

### CROSS-REFERENCE TO RELATED APPLICATIONS

This International application claims the benefit under 35 U.S.C. § 119(e) of Application Ser. No. 63/001,622 filed on Mar. 30, 2020 entitled INVENTORY SYSTEM AND METHOD FOR MEASURING THE CONTENTS OF FULL AND PARTIALLY-FILLED ALCOHOL BEVERAGE CONTAINERS and whose entire disclosure is incorporated by reference herein.

### BACKGROUND OF THE INVENTION

This present invention relates to a computer based system used for taking physical inventory of the contents of alcoholic beverage containers. Where alcoholic beverages are not served from single size serving containers, they are dispensed from partially full containers. Failure to keep accurate inventory can result in an inconsistent stock of liquor, resulting in lost sales or lost patronage. Additionally, employee responsibility for correctly dispensing amounts of liquor or theft can also result in not properly tracking inventory.

Current methods for tracking inventory of partially full containers is difficult, inaccurate, and time consuming. One common method is having a person look at a bottle and then to estimate the quantity in ten percentage point increments. This method is rarely more accurate than ten percentage points, and is often conducted by the same person to try to maintain consistency. Poor inventory practices hurt businesses, yet the time, labor, and scheduling required to accurately take inventory are troublesome.

One attempt to control liquor inventory involves mechanical methods for pouring specific quantities of liquor from a gun, spout, or other mechanical means. While this method controls the amount of liquor dispensed, it is time consuming and doesn't count inventory. U.S. Pat. No. 4,563,739 (Gerpheide, et al.) shows an inventory and business management system which accounts for the contents of full and partially filled product containers. The apparatus disclosed therein includes a keyboard, interface, carrying case, and wand barcode reader. The data is primarily intended to be stored in the apparatus' memory and utilized as a printed report. Additionally, a product record has to be pre-loaded into the computer memory. The description of this product suggests it is a manually loaded, self-contained inventory system, used for publishing paper inventory reports. It requires connection to an electrical outlet. Other manual operation of the product includes entering the date, using commands to initiate operation, and adding inventory items. In particular, the patent states, “For liquors, a substantial amount of information is entered with respect to each product, as shown at 96” with regard to an “update product record” flow diagram in FIG. 7. Moreover, the patent discloses with regard to a “set-up operation” flow diagram of FIG. 5 that “updating the size of each liquor pour or serving size dispensed as shown at 120. Updating the information shown at [steps] 114, 116, 118 and 120 entails entering the new information from the keyboard.”

Another prior art method for automated liquor inventory is found in U.S. Pat. No. 5,986,219 (Carroll, et al.). Utilizing a weight scale and computer, bottles are separated by category and weighed. This seems like a prima facie improvement over the Gerpheide method. Unfortunately, estimates of this style by categorization/weight fail to improve inventory tracking, and are mostly helpful from a financial perspective only.

A further prior art method for the inventory of partially full bottles is U.S. Pat. No. 6,616,037 (Grimm, et al.). The method includes the use of barcodes to identify the bottles as well. They do not weigh the bottle however; their method relies on users to estimate the amount of the bottle on a computer generated silhouette. Their abstract cites, “controlling theft and over pouring” as a reason for their invention, yet their inventory system relies on people to manually input data. While the silhouette method probably increases accuracy compared to simply looking at the bottle, the data is still subject to user input error or malicious data entry.

However, there remains a need for a system and method that accurately measures the volume of full or partially-filled containers using a standard barcode and weight detection. The present invention solves this problem.

All references cited herein are incorporated herein by reference in their entireties.

### BRIEF SUMMARY OF THE INVENTION

An apparatus for measuring the volume of a full or a partially-filled container as well as identifying the contents of the container by scanning a universal product code (UPC) label on the container to form container data and communicating the container data to a remote database is disclosed. The apparatus comprises: a load cell for detecting the weight of the container; a barcode scanner for scanning the UPC label on the container; and a processor coupled to the load cell and the barcode scanner for activating the load cell and the barcode scanner to generate the container data, and wherein the processor receives the container data and is configured for wirelessly transmitting the container data to the remote database over global computer networks.

A method for measuring the volume of a full or a partially-filled container as well as identifying the contents of the container by scanning a universal product code (UPC) label on the container to form container data and communicating the container data to a remote database while eliminating manual input of the container data is disclosed. The method comprises: providing a load cell upon which the container is positioned for detecting the weight of the container; providing a barcode scanner for scanning the UPC label on the container when the UPC label is positioned opposite a scanning window of said barcode scanner; connecting a processor to the load cell and to the barcode scanner for activating the load cell and the barcode scanner to generate the container data; receiving the container data, by the processor, from the load cell and the barcode scanner; wirelessly transmitting, by the processor, the container data to the remote database over global computer networks.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a system diagram of the present invention;

FIG. 2 is a functional diagram of the operation of the present invention; and

FIG. 3 is an isometric view of a bottle positioned on the apparatus of the present invention depicting use of the apparatus.

### DETAILED DESCRIPTION OF THE PREFERRED EMBODIMENTS

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

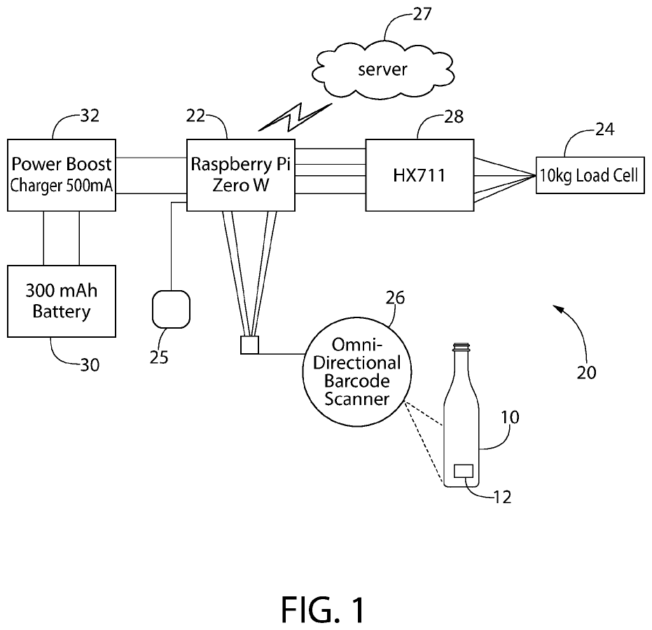

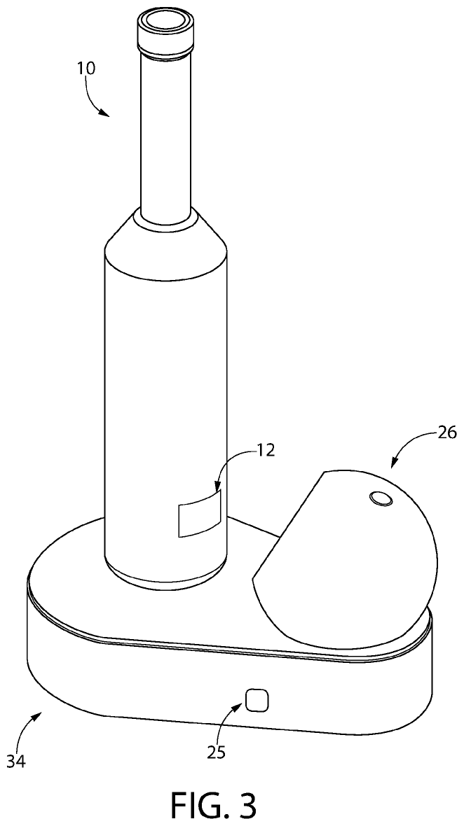

As shown in FIG. 1, the apparatus and method of the present invention 20 comprises a processor 22 (e.g., Raspberry Pi Zero W single-board computer having a single core processor with 512 MB of RAM with LAN and Bluetooth capability) with wireless connectivity which is coupled to an omni-directional barcode reader 26 (e.g., Honeywell MS7120-38-3 Barcode Scanner). In addition, a load cell 24 (e.g., a Sparkfun Electronics SEN-13329 10 kg load cell,) is coupled through a load cell amplifier 28 (e.g., Sparkfun Load Cell Amp HX711) to the processor 22. The output power source 30 (e.g., a 3.7V Lithium-Ion Battery Rechargeable (secondary) 500 mAh) is fed through a power boost charger 32 (e.g., MCP73831 Battery Charger Power Management Evaluation Board) to the processor 22. As also shown in FIG. 1, the processor 22 has wireless connectivity to communicate with a remote database or memory (e.g., server, etc.) in the cloud 27. An on/off switch 25 is coupled to the processor 22 to initiate the inventive process 20. The apparatus 20 comprises a housing 34 (FIG. 3) in which all of the electronics are housed. The housing 34 is waterproof to protect the processor 22, load cell 24, battery 30 and other related electrical components therein. The apparatus 20 automatically shuts off after a period of idleness to preserve battery 30 life. The barcode scanner 26 is positioned on a top portion of the housing 34 adjacent the load cell 24 so that the barcode scanner 26 can read the Universal Product Code (UPC) label while the load cell 24 is weighing the bottle 10. Furthermore, the omni-directional barcode scanner 26 can read the UPC regardless of the orientation of the UPC label, e.g., if the UPC label is affixed in horizontal position on the bottle 10 or in a vertical position on the bottle 10.

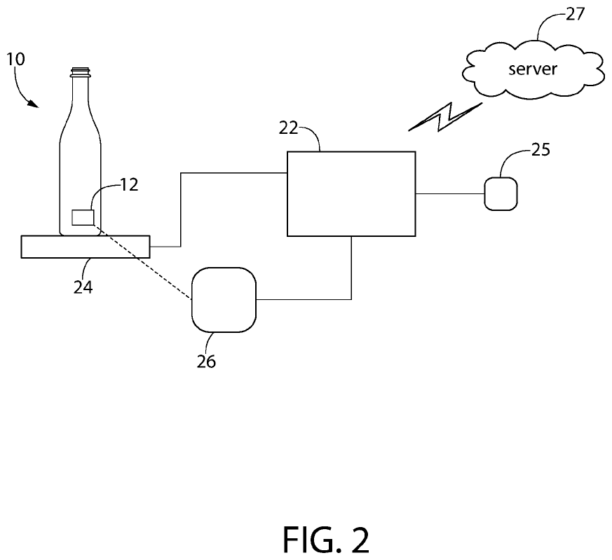

In operation, as shown in FIGS. 2-3, the apparatus 20 is turned on with the switch 25 and automatically connects to a preferred wireless Internet configured in advance by the establishment (e.g., dram shop, bar, restaurant, etc.). The apparatus 20 is carried to a convenient location behind the bar, and a partially filled container 10 is placed on the load cell 24 with its associated barcode label 12 facing a scanning window (not shown) of the barcode scanner 28. As such, the pertinent information of the partially-filled bottle 10 is obtained by barcode scanner 28 by reading the label 12; the weight is simultaneously captured by the load cell 24. This data is passed to the processor 22 and sent via wireless Internet to the cloud-based memory 27. The bottle 10 is removed and the next bottle 10 is placed on the load cell 24. In this manner, all partially-filled containers 10 are measured by weight. There is no display or user input required; thus reducing and/or eliminating the accidental or erroneous input of data.

The apparatus 20 aids in obtaining inventory and producing financial reports, but it improves upon the previous devices in several ways. First, there are no barcodes to affix. By using the UPC-A format (12 digit number) barcode already in use by retailers and printed on the label 12 by manufacturers, use of the apparatus 20 doesn't require additional administrative effort. In this manner, each bottle 10 is accounted for, rather than the average as found in the device of U.S. Pat. No. 5,986,219 (Carroll, et al.). Technologically, the battery 30, omni-directional barcode reader 26, and wireless processor 22 all contribute to the ease of use. Furthermore, there is no input or output for the user to adulterate or manipulate, thus preventing inaccurate readings. Finally, the electronic format of the data allows data analysis of inventory trends and correlation.

While the invention has been described in detail and with reference to specific examples thereof, it will be apparent to one skilled in the art that various changes and modifications can be made therein without departing from the spirit and scope thereof.

1. An apparatus for measuring the volume of a full or a partially-filled container as well as identifying the contents of the container by scanning a universal product code (UPC) label on the container to form container data and communicating the container data to a remote database, said apparatus comprising:
a load cell for detecting the weight of the container;
a barcode scanner for scanning the UPC label on the container; and
a processor coupled to said load cell and said barcode scanner for activating said load cell and said barcode scanner to generate the container data, said processor receiving the container data and configured for wirelessly transmitting the container data to the remote database over global computer networks.

2. The apparatus of claim 1 wherein said barcode scanner is an omnidirectional barcode scanner for reading the UPC label regardless of an orientation of the UPC label on the container.

3. The apparatus of claim 1 wherein said apparatus comprises a rechargeable battery for powering said load cell, barcode scanner and said processor.

4. The apparatus of claim 1 further comprising a housing for containing said load cell, said processor and associated electronics therein, said housing being waterproof.

5. The apparatus of claim 4 wherein said barcode scanner is positioned on a top portion of said housing, adjacent said load cell, such that said barcode scanner is configured to read the UPC label while said load cell is weighing the container.

6. A method for measuring the volume of a full or a partially-filled container as well as identifying the contents of the container by scanning a universal product code (UPC) label on the container to form container data and communicating the container data to a remote database while eliminating manual input of the container data, said method comprising:
providing a load cell upon which the container is positioned for detecting the weight of the container;
providing a barcode scanner for scanning the UPC label on the container when the UPC label is positioned opposite a scanning window of said barcode scanner;
connecting a processor to said load cell and to said barcode scanner for activating said load cell and said barcode scanner to generate the container data;
receiving the container data, by said processor, from said load cell and said barcode scanner;
wirelessly transmitting, by said processor, the container data to the remote database over global computer networks.

7. The method of claim 6 wherein said barcode scanner is an omni-directional barcode scanner for reading the UPC label regardless of an orientation of the UPC label on the container.

8. The method of claim 6 wherein said step of providing a processor further comprises providing a rechargeable battery for powering said load cell, barcode scanner and said processor.

9. The method of claim 6 wherein said step of providing a processor comprises providing a rechargeable battery for powering said load cell, barcode scanner and said processor.

10. The method of claim 6 further comprising the step of positioning said load cell, said processor and associated electronics within a waterproof housing.

11. The method of claim 10 wherein said step of providing said barcode scanner comprises positioning said barcode scanner on a top portion of said housing, adjacent said load cell, such that said barcode scanner is configured to read the UPC label while said load cell is weighing the container.

12. The method of claim 6 wherein said step of providing a processor further comprises providing an on/off switch connected to said processor, said on/off switch being activated by an operator to command said processor to activate said load cell and said barcode scanner.
